(19) United States
(12) Patent Application Publication
(10) Pub. No.: US 2006/0127637 A1
(43) Pub. Date: Jun. 15, 2006

(54) System comprising organic or metallo-organic energy and/or charge variable moieties

(75) Inventors: Johannes Willem Hofstraat, Eindhoven (NL); Egbert Willem Meijer, Waalre (NL); Albertus Petrus Hendrikus Johannes Schenning, Oisterwijk (NL); Freek Johannes Maria Hoeben, Asten (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/559,839

(22) PCT Filed: Jun. 4, 2004
(86) PCT No.: PCT/IB04/50840

§ 371 Date: Dec. 8, 2005

(30) Foreign Application Priority Data
Jun. 13, 2003 (EP) 03101742.9

(51) Int. Cl. B32B 3/04

(52) U.S. Cl. 428/122

(57) ABSTRACT

The invention relates to a system for use in an electric or optical device comprising at least two organic or metallo-organic energy and/or charge variable moieties having conjugated unsaturated bonds, wherein at least one moiety has an energy state different from another of said moieties, characterized in that the system is a H-donor-Hacceptor system comprising at least one H-donor molecule having at least two hydrogen bonding clusters, each cluster comprising at least two groups having formed a hydrogen bond, and at least two H-acceptor molecules, each having at least one hydrogen bonding cluster, each cluster comprising at least two groups having formed a hydrogen bond with the groups of the H-donor molecule, at least one of the H-donor and H-acceptor molecules 10 further comprising one or more of the organic or metallo-organic energy and/or charge variable moieties.

System comprising organic or metallo-organic energy and/or charge variable moieties The invention relates to a system comprising at least two organic or metallo-organic energy and/or charge variable moieties having conjugated unsaturated bonds, wherein at least one moiety has an energy state different from another of said moieties for use in an electric or optical device and to an electronic device comprising said system.

Such systems and electronic devices comprising said systems are known in the art as such. For example, electroluminescent devices are known which have an electroluminescent layer, which includes a semi-conducting polymer, which is mixed with a luminescent dye. In such a device light emission from the dye is achieved by charge injection from electrodes (holes from the anode, electrons from the anode) into the electroluminescent layer producing hole and electron states in the semi-conducting polymer which states are then transferred within the polymer. Hole and electron states meet on the polymer to form an excited state. The excited state on the polymer is then transferred to bring the luminescent dye into an excited state which state may then revert back to the ground state by emission of a photon of light. In another known example of such a system a first and a second moiety are dyes having an excited state of different energy leading to a different absorption and emission color.

A known type of such material system is one wherein the first and second moieties are incorporated in separate compounds, which are mixed together to form the material system. A drawback of such type of system is that if such system is used in the form of a thin film of an electronic device the first and second moieties have a tendency to migrate relative to another during the service life of the device, on occasion, even to the extent that phase-separation or aggregation occurs. Such migration changes the properties of the electronic device during operational lifetime, which is undesirable. When used in electronic devices such systems may be used for obtaining layers for full-color displays. These require the availability of pure red, green, and blue emitters. The different emission colors are realized by application of a blue luminescent material, doped with suitable green and red emitting luminophores. The use of such single molecule dopants, usually applied as solid solution in an electroluminescent material, is well known in the art, as is the problem of migration of the low molecular weight material in the polymer. In lighting systems the problem is in the realization of pure white emitting layers. Also in such layers combinations of different emitters are used.

Another known type of material system is one first and second moiety incorporated in a polymer as distinct structural units. Being covalently linked together, the problem of migration is solved but for each combination of first and second organic moiety a separate synthetic effort is required which is laborious and not versatile. Also, synthesis and thin film formation of such integrated systems is generally difficult to do in a controlled manner, since the thin films generally have a relative large number of defects such as impurities. This is particularly true when the integrated system is a polymer. In view of its large molecular weight a polymer is difficult to purify and analyze. Also, with polymers, morphology is an important parameter for device performance yet is difficult to control. Lack of control and a relatively high defect density obviously has a negative impact on device performance and reproducibility of device manufacture of electronic devices comprising thin films formed of such integrated systems.

It is an object of the invention to take away or at least mitigate the above-mentioned drawbacks. Specifically, an object is to provide a material system which is suitable for use in an electric or optical, electronic and electro-optical in particular, device, which can be synthesized and formed into thin films in a controlled and versatile manner and has a significantly lower level of defects than conventional integrated material systems. Like systems having the first and second moieties in separate compounds, it should be easy to form new combinations. However, unlike systems having the separate first and second moiety, migration during operational lifetime of a device comprising such system should be substantially absent.

These and other objects are achieved using a system as mentioned in the opening paragraph, which in accordance with the invention, is characterized the system is a H-donor-H-acceptor system comprising at least one H-donor molecule having at least two hydrogen bonding clusters, each cluster comprising at least two groups having formed a hydrogen bond, and at least two H-acceptor molecules, each having at least one hydrogen bonding cluster, each cluster comprising at least two groups having formed a hydrogen bond with the groups of the H-donor molecule, at least one of the H-donor and H-acceptor molecules further comprising one or more of the organic or metallo-organic energy and/or charge variable moieties.

It has now been found that novel systems comprising charge and/or energy variable moieties having states of different energy bound together by hydrogen bonds provide an extremely versatile way to compose electrical or optical, in particular electronic and electro-optical and electroluminescent, materials. The resulting material forms a stable layer, which is held together with hydrogen bonds and has excellent mechanical properties. It was found that supramolecular systems as described in A. El-ghayoury, et al., Angew. Chem.. 2001-40/19, p. 3660-3663, and in A. Schenning, et al., J. Am. Chem. Soc. 2001, 123, p. 409-416 for use in other applications than the instantly claimed electric or optical devices with different energy and/or charge variable moieties, could form the basis for suitable materials for use in the instantly claimed electronic devices. These references describe the synthesis and organization of chiral π-conjugated oligo(p-phenylene vinylene) (OPV) molecules, such as MOPV and 13OPV. Both MOPV and BOPV contain an organic energy variable moiety rendering these molecules suitable for use in electronic devices, such as LEDs (light emitting diodes), solar cells, and FETs (field effect transistors). These systems are self-assembled, and depending on the condition used the bifunctional BOPV may form a random coil polymer of frustrated stacks, but the assemblies disclosed therein are do not have at least two organic or metallo-organic energy and/or charge variable moieties having conjugated unsaturated bonds, wherein at least one moiety has an energy state different from another of said moieties and accordingly do not have the problem of migration.

The present inventors have now found that such systems could very well be used for the presently claimed type of electronic devices when such systems were so changed that at least one moiety has a different energy state than the other moieties. The inventors farther realized that such system could provide a versatile system not having the hereinabove mentioned migration problems and being perfectly suitable for the above-mentioned types of electronic devices.

The terms “H-donor” and “H-acceptor” only relate to molecules that provide the hydrogen atom for bonding (H-donor) or accept the hydrogen atom for bonding (H-acceptor). These terms are only relative, since the same H-donor molecule can also be an H-acceptor molecule and vice versa. It is also possible that one groups acts as H-donor hydrogen, whereas another group in the same molecule acts as H-acceptor hydrogen.

The term “energy and/or charge variable” as used for the organic or metallo-organic moieties having conjugated unsaturated bonds means that such moieties are able to change their energy state by accepting or donating electrons, holes or photons.

Since the starting material is a small low molecular weight) molecule, which can be prepared and purified with synthetic methods typical for molecular synthetic organic chemistry, extremely pure and well-controlled electroluminescent materials can be prepared. To obtain a sufficient thermal and mechanical stability, the H-bonding structures should be constructed so that multiple bonds are supported in a geometric fashion that affords the formation of several H-bonds simultaneously. For example, one may use materials built up through quadruple hydrogen-bonded self-complementary ureido-pyrimidone units. Mixed molecules, equipped to sustain multiple H-bonds, for generation of white light (lighting) and for generation of pure emission (red, green, and blue) for full-color displays can be easily obtained, by mixing of the appropriate emitters. The charge transfer properties of the layer or layers comprising the active stack in a thin-film electronic device may be optimized by application of suitable energy and/or charge transfer moieties.

Hydrogen bonds are well known and can be obtained by O-, N-, S-, and P-containing units. The strongest hydrogen bonds are usually found for N and O units, and for that reason the preferred hydrogen bond is an N—H—N, O—H—O, or N—H—O bond.

To give highly ordered structures, e.g. “tapered” systems of monomers the H-donor and H-acceptor molecules are organized. The approach is most suitable for systems of similar molecules, wherein the H-acceptor molecule hydrogen bonding groups are complementary to the hydrogen bonding groups of the H-acceptor molecule.

The organic energy and/or charge variable moiety is a group that allows energy transfer, such as exciton, hole, or electron (charge) transfer, or a combination of functionalities. Preferred organic energy variable moieties are semi-conductors and/or (luminescent) dyes.

The system can be a supramolecular H-bonded polymeric assembly, which is an assembly of distinct molecules that are linked together by H-bonds. More particularly, in order to obtain a stable assembly, the molecules forming the assembly each have one or more hydrogen bonding clusters. A hydrogen bonding cluster is a structural unit which comprises at least two, preferably three or four, hydrogen bonding groups which each have formed a hydrogen bond with one of the hydrogen bonding groups of a hydrogen bonding cluster of another molecule of the assembly. A supramolecular H-bonded assembly which is polymeric is obtained if the assembly comprises a plurality of molecules which each have at least two hydrogen bonding clusters, and which are otherwise structurally the same or different, wherein the molecules are connected to each other via the H-bond clusters to form a chain or chains of such molecules within the assembly.

The molecules comprising the H-bond clusters are compared to polymers relatively small and are consequently easy to obtain in high purity and do not have a distribution in molecular weight. Since the H-bonded assembly is assembled in situ., that is during orjust prior to thin film formation, each new combination of H-donor and H-acceptor does not require a separate synthetic effort. On the other hand, since the bond between two hydrogen bonding clusters is strong, the strength may approach or even be the same as that of a covalent bond, migration typical fbr assemblies having separate guests and hosts is effectively prevented. Efficient energy transfer requires the donor state to be of equal or higher energy than the acceptor state, close proximity of the moieties between transfer is to take place and proper mutual orientation of such moieties. Since H-bonds are highly directional and assembly proceeds in an orderly manner the supramolecular assembly in accordance with the invention is very well suited to satisfy these requirements.

A supramolecular H-bonded polymeric assembly is known as such in the form of polymeric assemblies of bifunctional ureidopimidone derivates from Brunsveld, et al, Chem. Rev., 101 (12), p. 4071-4097 and from R. P. Sijbesma and E. W. Meijer, Current Opinion in Colloid & Interface Science 1999:4, p. 24-32. These systems are suggested to be useful in catalysis and material science, and are not suitable for use in electronic devices since they do not contain groups that are able to transfer energy.

By way of example, the principle of the invention is illustrated by the following schematic representation. The rectangles represent an organic energy and/or charge variable moiety; the triangles represent a hydrogen-bonding cluster comprising at least two H-bonding groups. In the scheme a bifunctional molecule is depicted comprising two H-bonding clusters and two semiconductor moieties. A more specific example of such a molecule is given (BOPV). Molecules with more or less hydrogen bonding clusters and energy and/or charge variable moieties can also be used. This molecule represents the H-donor molecule, which together with an H-acceptor molecule forms the system. The hydrogen bonding groups in the clusters of the H-donor and H-acceptor molecules are complementary and form a hydrogen bond to each other.

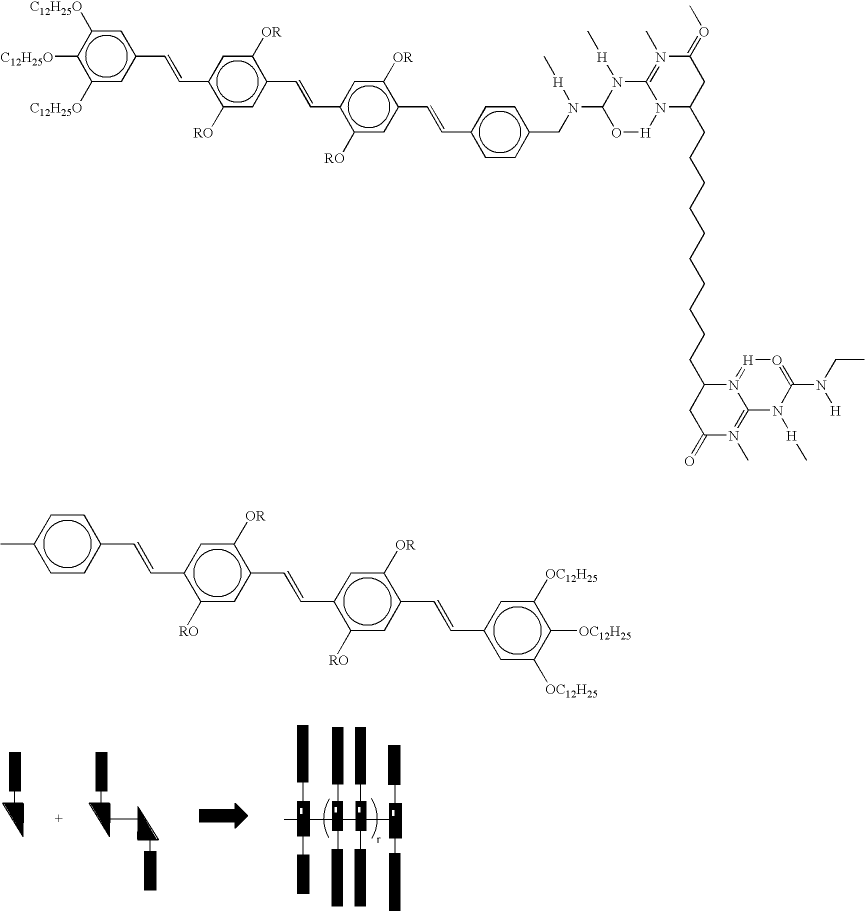

The larger rectangles represent energy and/or charge variable moieties with a lower energy state. Such energy and/or charge variable moiety may be a dye. The triangles represent hydrogen-bonding clusters. This system is particularly useful when applied in LEDs. In a energy variable moiety of lower energy state the LUMO is of a lower energy state, the HOMO is of a higher energy state, or the distance between the LUMO and HOMO levels is smaller than in the other energy variable moieties. When, for instance, using OPVs of different conjugation length as building blocks, mixed columns arise. Upon excitation the short H-donor OPVs funnel their energy to the longer OPVs of lower energy state, which act as energy traps inside the stack.

It is required that the energy and/or charge variable moieties comprise conjugated unsaturated bonds, such as aromatic moieties, particularly benzene, or homonuclear or heteronuclear aromatic groups, and aliphatic polyene systems, such as dienes, trienes, and also polyene systems comprising triple unsaturated bonds.

Preferably, the H-donor-H-acceptor system comprises at least 2 of the H-donor molecules and at least 3, preferably at least 4, of the H-acceptor molecule. Examples of systems according to the invention are, for instance, given by the following schematic representations. 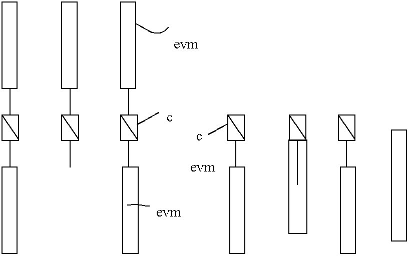
wherein evm is the energy and/or charge variable moiety, for instance a semi-conductive moiety, and c is the hydrogen bonding cluster. For simplicity only one cluster is depicted, but at least one of the H-donor or H-acceptor molecules comprise at least two of such clusters.

It is clear that the H-donor and H-acceptor molecules can be used as building blocks for obtaining many various systems, such as chains, monoclusters, multiclusters, networks, and the like, and combinations thereof.

The systems in accordance with the invention are supramolecular H-bonded polymers. Such H-bonded polymers are analogous to and accordingly are readily available in the same variety as conventional polymer in which repeating units are covalently linked together to form the polymer, the H-acceptor and H-donor molecules of the H-polymer being the analogue of the repeating unit. Consequently, H-bonded polymers may be provided in the form of co-polymers, for example of the AABB or the AB repeating unit type or as a cross-linked systems if three or more H-bonding clusters are used in a H-donor or acceptor optionally in combination donor/acceptor having two clusters. Side-chain and main-chain H-polymers are also easily obtained. The charge and/or energy moieties may be included anywhere within the H-bond polymer, for example spliced between two H-bonding clusters of a molecule or as a pendant group by means of a molecule having only a single H-bonding cluster.

In another preferred embodiment the invention relates to a H-donor-H-acceptor system comprising at least one H-donor molecule having at least two hydrogen bonding clusters, each cluster comprising at least two groups having formed a hydrogen bond, and at least two H-acceptor molecules, each having at least one hydrogen bonding cluster, each cluster comprising at least two groups having formed a hydrogen bond with the groups of the H-donor molecule, at least one of the H-donor and H-acceptor molecules further comprising at least an organic or metallo-organic energy and/or charge variable moiety having conjugated unsaturated bonds, wherein at least one of the H-acceptor and H-donor has formed a complex or is bonded to a backbone having a plurality of hydrogen bonding clusters.

Examples of systems according to this embodiment comprise systems covalently or ionogenically bonded to a backbone having a plurality of hydrogen bonding clusters such as polymers or oligomers. Such bonding of poly- and oligomers can also be in the form of a complex with the H-donor, H-acceptor, or both. Any suitable poly- and oligomers can be used, such as polyethers, polyamides, polyacrylates, polyurethanes, oligomers thereof, mixed oligo- and polymers, and the like. Such poly-and oligomers may be linear, branched or hyperbranched. A particularly suitable form is a poly-or oligomer being complexed to the H-acceptor, H-donor, or both. A few non-limitative embodiments of the invention are, for instance, given by the following schematic representations. 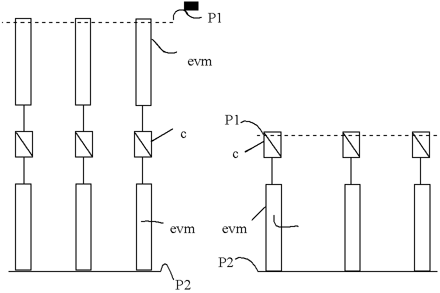
wherein evm is the energy and/or charge variable moiety, for instance a semi-conductive moiety, and c is the hydrogen bonding cluster. P1 and P2 are a polymer or oligomer, of which at least one is present. The polymers can be bonded to the energy transfer and/or charge moiety or directly to the hydrogen-bonding cluster. As above, at least one of the energy transfer and/or charge moieties may have a lower energy state than the other organic energy variable moieties, but when using the polymeric or oligomeric additive this is no longer prerequisite.

In a specific embodiment the polymer is a hyperbranched polymer, such as a dendrimeric compound, which can form a complex with the H-donor-H-acceptor molecule of the invention, for instance via a binding motive as was described in Baars, et al., Angew. Chem. Int. Ed. 2000, (39), p 4262-4265. In the case of the supramolecular dendritic H-acceptor-H-donor system smooth homogeneous thin films could be obtained by spin coating. The dendritic H-donor-H-acceptor complexes showed a significantly higher emission upon binding then that of the individual molecules due to the three-dimensional orientation of the H-donor molecules. In the solid state this enhancement in luminescence was a factor of ten. The complex may be represented as in the following figure (wherein the symbol above the reaction arrow represents the H-donor or H-acceptor).

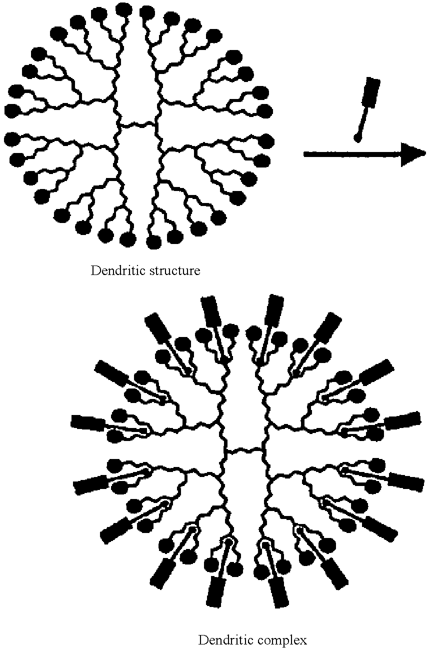

For easy manufacturing of electronic devices, such as a electroluminescent device (particularly LED's), field-effect transistor, sensor or photovoltaic device, it is advantageous that the H-donor and H-acceptor molecules dissolve in a solvent, to obtain a solution with suitable viscosity to (spin-)coat or print it onto a substrate.

The invention is further illustrated by the following non-limitative examples.

### EXAMPLE 1

1,6-Bis{2-amino-4-hexadiylureido-6-[(E,E)-4-(4-{3,4,5-trisdodecyl-oxystyryl}-2,5-bis[(S)-2-methylbutoxy]styryl)phenyl]-s-triazine} (BOPV-3) and 4-amino-2-butylureido-6-[(E,E,E,E)-4-{4-[4-(4-{3,4,5-trisdodecyloxystyryl}-2,5-bis[(S)-2-methylbutoxy]styryl)-2,5-bis[(S)-2-methylbutoxy]styryl]-2,5-bis[(S)-2-methylbutoxy]styryl}phenyl]-s-triazine (MOPV-5) were prepared according to the method of A. Schenning, et al., J. Am. Chem. Soc., 2001, 123, p.409-416.

The hydrogen-bonded systems have been applied in LEDs in order to investigate their suitability as active medium in an electroluminescent device.

The OLED was prepared using glass covered with indiumtinoxide (ITO) as transparent conductive substrate. A thin (135 nm) layer of the conductive polymer poly(ethylenedioxythiophene) (PEDOT), applied by spin-coating from an aqueous suspension of PEDOT with polystyrene sulfonic acid, was used as hole transporter. On top of the PEDOT layer, a very thin (about 70 nm) layer of BOPV-3 and BOPV-5 (10%) was applied by spin-coating. Finally, the cathode was applied by evaporation of 5 nm Ba (rate 0.1 nm/s) and 70 nm A1 (rate 1 nm/s).

The OLED was characterized by investigation of the current vs. voltage and luminance vs. voltage curves. The OLED has a turn-on voltage of approximately 2.5 V and shows a clear orange electroluminescence. The device properties of the BOPV-3 and BOPV-5 mixture prove that hydrogen-bonded units, e.g. urideo-triazine units, and that the concept of mixed systems, can be applied in OLEDs.

### EXAMPLE 2

(Dendritic Structure)

Synthesis of (E,E,E)-4-[4-{3,4,5-tridodecyloxystyryl)-2,5-bis[(S)-2-methylbutoxy]styryl}-2,5-bis[(S)-2-methylbutoxy]styryl}phenyl]ureido acetic acid methyl ester.

To a stirred solution of (E,E,E)-4-[4-{3,4,5-tridodecyloxystyryl)-2,5-bis[(S)-2-methylbutoxy]styryl}-2,5-bis[(S)-2-methylbutoxy]styryl] phenyl isocyanate (see Peeters, E; van Hal, P. A.; Meskers, S. C. J.; Janssen, R. A. J.; Meijer, E. W., Chem. Eur. J. 2002, 8, 4470, and Syamakumari, A; Schenning, A. P. H. J.; Meijer, E. W., Chem. Eur. J. 2002, 8, 3353) in dry dichloromethane (3 ml) was added Et₃N (0.4 ml) and glycine methyl ester hydrochloride (53 mg, 1.1 eq). The mixture was stirred overnight at room temperature. The product was washed with diluted aqueous hydrochloride solution (0.2 M) and a saturated solution of NaCl. The organic layer was dried over Na₂SO₄, filtrated and concentrated in vacuo to yield 0.4 g of (E,E,E)-4-[4-{3,4,5-tridodecyloxystyryl)-2,5-bis[(S)-2-methylbutoxy]styryl}-2,5-bis[(S)-2-methylbutoxy]styryl}phenyl]ureido acetic acid methyl ester) (80% yield) as a yellow solid. 7 eq of LiOH.H₂O were added to a solution of the above methyl ester (1 eq) in ThBF (tetrahydrofuran). The solution was stirred overnight (15 h) and the acid was precipitated by acidification with HCl 1M (pH 2). The resulting solid was filtered off, dried under high vacuum and then washed with hexane at room temperature giving OPV-5): (E,E,E)-4-[4-{3,4,5-tridodecyloxystyryl)-2,5-bis[(S)-2-methylbutoxy]styryl}-2,5-bis[(S)-2-methylbutoxy]-styryl]ureido acetic acid (Mp: 122° C.).

Complexation of OPV-5 with the fifth generation polypropylene imine) dendrimer functionalized with urea adamantyl units at the periphery was simply achieved by addition of 32 eq of OPV-5 to a solution of the dendrimer.

1. A system for use in an electric or optical device comprising at least two organic or metallo-organic energy and/or charge variable moieties having conjugated unsaturated bonds, wherein at least one moiety has an energy state different from another of said moieties, characterized in that the system is a H-donor-H-acceptor system comprising at least one H-donor molecule having at least two hydrogen bonding clusters, each cluster comprising at least two groups having formed a hydrogen bond, and at least two H-acceptor molecules, each having at least one hydrogen bonding cluster, each cluster comprising at least two groups having formed a hydrogen bond with the groups of the H-donor molecule, at least one of the H-donor and H-acceptor molecules further comprising one or more of the organic or metallo-organic energy and/or charge variable moieties.

2. The system of claim 1 wherein the hydrogen bond is an N—H—N, O—H—O, or N—H—O bond.

3. The system of claim 1 or 2 comprising at least 2 of the H-donor molecules and at least 3, preferably at least 4, of the H-acceptor molecules.

4. The system of any one of claims 1-3 wherein the organic or metallo-organic energy and/or charge variable moieties are semi-conductors.

5. The system of any one of claims 1-4 wherein the organic or metallo-organic energy and/or charge variable moieties having the lowest energy state is a luminescence dye.

6. The system of any one of claims 1-5 wherein the H-donor and H-acceptor molecules are soluble in a solvent.

7. A system for use in an electric or optical device comprising at least two organic or metallo-organic energy and/or charge variable moieties having conjugated unsaturated bonds, wherein at least one moiety has an energy state different from another of said moieties, characterized in that the system is a H-donor-H-acceptor system comprising at least one H-donor molecule having at least two hydrogen bonding clusters, each cluster comprising at least two groups having formed a hydrogen bond, and at least two H-acceptor molecules, each having at least one hydrogen bonding cluster, each cluster comprising at least two groups having formed a hydrogen bond with the groups of the H-donor molecule, at least one of the H-donor and H-acceptor molecules further comprising at least an organic or metallo-organic energy and/or charge variable moiety having conjugated unsaturated bonds, wherein at least one of the H-acceptor and H-donor has formed a complex or is bonded to a backbone having a plurality of hydrogen bonding clusters.

8. The system of claim 7 wherein the organic or metallo-organic energy and/or charge variable moieties are semi-conductors.

9. An electronic device having at least two electrodes with at least one layer of the system of any one of claims 1-8 dispersed therein between.

10. The electronic device of claim 9 wherein the device is an electroluminescent device, field-effect transistor, sensor or photovoltaic device.
